(19) United States
(12) Patent Application Publication
(10) Pub. No.: US 2022/0212714 A1
(43) Pub. Date: Jul. 7, 2022

(54) STEERING SYSTEM FOR A MOTOR VEHICLE

(71) Applicant: ZF Automotive Germany GmbH, Alfdorf (DE)

(72) Inventors: Eduard Span, Koeln (DE); Clemens Krueger, Neuss (DE)

(21) Appl. No.: 17/568,815

(22) Filed: Jan. 5, 2022

(30) Foreign Application Priority Data
Jan. 6, 2021 (DE) 102021200051.7

(51) Int. Cl. B62D 5/04; B62D 3/12

(52) U.S. Cl. CPC B62D 5/0454; B62D 3/126; B62D 5/0424

(57) ABSTRACT

The disclosure relates to a steering system for a motor vehicle, which is designed as a steer-by-wire steering system and comprises a rack, an electric drive for longitudinal displacement of the rack, a worm gear and a drive shaft which is in toothed engagement with the rack. The electric drive is connected to the drive shaft by the worm gear so as to transmit torque.

### CROSS-REFERENCE TO RELATED APPLICATION

This application claims priority to German Patent Application No. 102021200051.7, filed Jan. 6, 2021, the disclosure of which is incorporated herein by reference in its entirety.

### TECHNICAL FIELD

The disclosure relates to a steering system for a motor vehicle, which is designed as a steer-by-wire steering system.

### BACKGROUND

Steering systems usually comprise a rack which is linearly displaceably mounted in order to adapt a wheel position. Originally, such a rack is coupled to the steering wheel via a handlebar, so that a linear displacement of the rack is achieved by rotating the steering wheel

In modern motor vehicles, a so-called steer-by-wire steering system (SBW steering system) can be used, in which there is no longer any mechanical connection between the steering wheel and the rack. The rack is displaced by an electric drive. Torsional forces can occur that act on the rack and cause undesired rotation of the rack.

Due to the no longer existing mechanical connection between the steering wheel and the rack, the mounting and guidance of the rack in a steer-by-wire steering system are different in comparison to conventional steering systems.

In particular, the requirements for the guidance of the rack change, since the electric drive in a steer-by-wire steering system can result in high thrust forces, for example higher than 13 kN, which must be taken into account when guiding the rack.

In addition, the electric drive transmits a torque to the rack. Torsional forces can occur that act on the rack and cause undesired rotation of the rack. In addition, the rack should in principle be guided with as little friction as possible, so that the rack can slide smoothly through the steering system when the motor vehicle is being steered.

Therefore what is needed is to provide a reliable steering system with which a rack can be adjusted, in particular in a steer-by-wire steering system.

### SUMMARY

In accordance with one exemplary arrangement, a steering system for a motor vehicle is provided, which is designed as a steer-by-wire steering system. The steering system comprises a rack, an electric drive for longitudinal displacement of the rack, a worm gear and a drive shaft which is in toothed engagement with the rack. Here, the electric drive is connected to the drive shaft by the worm gear so as to transmit torque.

It has been recognized that through use of the worm gear, the electric drive can be coupled in a particularly reliable and quiet manner to the drive shaft so as to transmit torque, since the worm gear has a high load-carrying capacity compared to other toothed drives.

In this exemplary arrangement, the worm gear has a worm wheel and a worm shaft which engages with the worm wheel. The worm wheel is connected to the drive shaft so as to transmit torque and/or non-rotatably, and the worm shaft is connected to the electric drive so as to transmit torque and/or non-rotatably. This has the advantage that the worm shaft with the electric drive can be aligned on the worm wheel depending on the space available. The steering system can thus be flexibly adapted to different space requirements and is therefore particularly compact.

Furthermore, in one exemplary arrangement, it can be provided that the electric drive comprises a first electric motor and a second electric motor. In this way, the reliability can be further increased via redundancy. Additionally or alternatively, the two electric motors can be designed to be smaller in comparison to a single electric motor, so that the required installation space can be reduced or arranged more advantageously.

According to one exemplary arrangement, the first electric motor and the second electric motor are connected to the worm wheel by a common worm shaft so as to transmit torque. This arrangement makes the steering system particularly compact.

According to an alternative exemplary arrangement, the worm gear has a second worm shaft which engages with the worm wheel. The first worm shaft is connected to the first electric motor so as to transmit torque and/or non-rotatably and the second worm shaft is connected to the second electric motor so as to transmit torque and/or non-rotatably. Since the two electric motors are each connected to the worm wheel via their own worm shaft, the reliability of the steering system is further increased. Furthermore, the two worm shafts can be designed to be smaller in comparison with a single worm shaft, as a result of which the weight and/or the required installation space can be reduced.

Furthermore, the first worm shaft and the second worm shaft can be arranged on mutually opposite radial sides of the worm wheel, in particular the axis of rotation of the first worm shaft extending parallel to the axis of rotation of the second worm shaft. This ensures an effective distribution of forces and the worm shafts can act as bearings for the worm wheel, so that a bearing assigned to the worm wheel can be made more compact or can be omitted entirely.

In one exemplary arrangement, the steering system has two bearing bushings which are spaced apart from one another in the longitudinal direction of the rack. The bearing bushings together form a rack guide. Furthermore, the drive shaft is arranged between the two bearing bushings in the longitudinal direction of the rack. The rack is effectively supported against deflection by the bearing bushings, so that reliable and precise engagement of the drive shaft and the rack is ensured. Furthermore, the rack can be mounted with particularly low friction by the bearing bushings.

Furthermore, it can be provided that the drive shaft is arranged, in a position of the steering system, in one exemplary arrangement, in a neutral position of the steering system, centrally with respect to the rack in the longitudinal direction of the rack. In this way, the forces acting can be distributed particularly evenly over the rack and thus the load on the rack can be reduced.

The steering system can have a pressure piece which is arranged in the region of the drive shaft and which supports the rack. More precisely, the pressure piece presses the rack against the drive shaft in order to ensure that the drive shaft remains in toothed engagement with the rack.

The pressure piece is made in one exemplary arrangement, of plastics material and can thus be produced with a low mass and inexpensively.

In a further exemplary arrangement, the steering system has a wireless torque sensor which is provided for determining the torque of the drive shaft. In this way, the force that is transmitted via the rack can be precisely determined.

Furthermore, the rack can have a toothing, via which the drive shaft is in toothed engagement with the rack. The rack may have a constant cross section from a first end to the toothing and from the toothing to a second end opposite the first end. In this way, the rack can be designed to be particularly resilient, in particular with regard to the deflection. Furthermore, the rack can thereby be cut deeper or flattened in the region of the toothing in order to provide a larger contact region between the drive shaft and the rack.

### BRIEF DESCRIPTION OF DRAWINGS

Further advantages and features can be found in the following description and in the accompanying drawings, in which:

FIG. 1 is a schematic side view of a steering system according to an exemplary arrangement,

FIG. 2 is a schematic plan view of the steering system from FIG. 1,

FIG. 3 is a schematic sectional illustration of a section through the steering system along the line A-A in FIG. 1, and

FIG. 4 is a schematic plan view of a steering system according to another exemplary arrangement.

### DETAILED DESCRIPTION

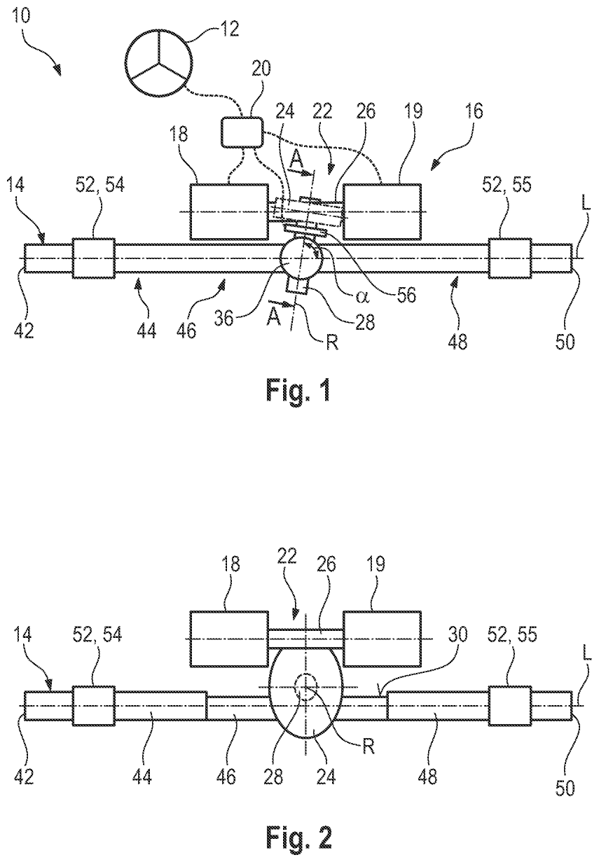

A steering system 10 for a motor vehicle is shown in FIG. 1.

The steering system 10 is a so-called steer-by-wire steering system in which there is no mechanical connection between a steering wheel 12, which can be operated by a driver, and the wheels of the motor vehicle for transmitting the steering movement,

The steering system 10 has a rack 14 and an electric drive 16. The electric drive 16 is set up for the longitudinal displacement, i.e. translational displacement, of the rack 14 in order to set a position of the wheels of the motor vehicle in accordance with a steering request by the driver.

In the exemplary arrangement shown, the electric drive 16 comprises a first electric motor 18 and a second electric motor 19.

In principle, the electric drive 16 can have any number of electric motors, and in one particular exemplary arrangement, only a single electric motor 18, 19.

The steering wheel 12 is coupled to the electric motors 18, 19 via a control unit 20 so as to transmit signals. As a result, there is only one electronic connection between the steering wheel 12 and the rack 14.

For the sake of clarity, the steering wheel 12 and the control unit 20 are not shown in FIG. 2 (or in FIG. 4).

In order to couple the electric drive 16 to the rack 14 so as to transmit torque, the steering system 10 comprises a worm gear 22 having a worm wheel 24 and a worm shaft 26 which engages with the worm wheel 24, as well as a drive shaft 28 which is in toothed engagement with the rack 14 via a toothing 30 (see FIG. 2).

The worm wheel 24 is non-rotatably connected to the drive shaft 28 and the worm shaft 26 is connected to the electric drive 16 so as to transmit torque.

For this purpose, the two electric motors 18, 19 are arranged at opposite ends of the worm shaft 26 and are controlled accordingly via the control unit 20 in order to drive the common worm shaft 26.

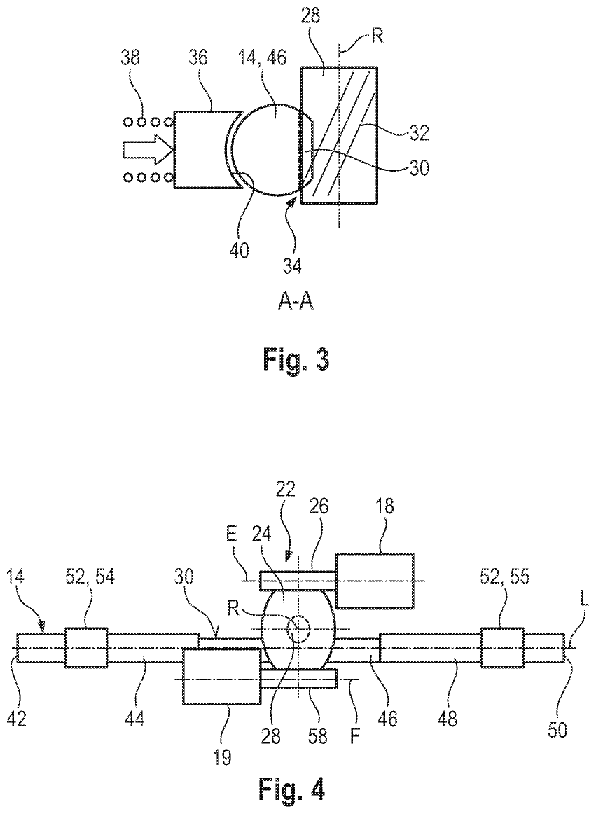

For the toothed engagement with the rack 14, the drive shaft 28 has a pinion-like portion 32 (see FIG. 3) in the contact region 34 with the toothing 30.

FIG. 3 shows a section in the region of the drive shaft 28 through the steering system 10 along the line A-A in FIG. 1.

The steering system 10 also has a pressure piece 36 which supports the rack 14 on the side opposite the contact region 34. As a result, deflection of the rack 14 is suppressed and thus a toothed engagement between the drive shaft 28 and the rack 14 is reliably ensured. Furthermore, the pressure piece 36 ensures effective suppression of noise.

In order to ensure a particularly stable toothed engagement, the steering system 10 can have a spring element 38 which acts on the pressure piece 36 with a spring force in the direction of the rack 14 or contact region 34, as is illustrated in FIG. 3 by an arrow.

In one exemplary arrangement, a contact surface 40 of the pressure piece 36 with the rack 14 is adapted to the geometry of the rack 14, and in one particular arrangement, concave.

In one exemplary arrangement, the pressure piece 36 is made of a plastics material.

In the exemplary arrangement shown, the axis of rotation R of the drive shaft 28 is inclined by an angle a of less than 90⁰ with respect to the longitudinal axis L of the rack 14. As a result, the contact region 34 is particularly large, so that forces are transmitted particularly effectively from the drive shaft 28 to the rack 14.

As shown in FIG. 2, the rack 14 extends from a first end 42 over a first end portion 44 to a toothed portion 46, which has the toothing 30, and from the toothed portion 46 over a second end portion 48 to a second end 50, which is arranged opposite to the first end 42.

Here, the toothing 30 is provided only in the toothed portion 46. This means that the toothing 30 does not extend in the direction of the longitudinal axis L over the entire length of the rack 14, but only over the toothed portion 46.

In one exemplary arrangement, the length of the toothing 30 or the toothed portion 46 corresponds to a maximum translational movement range of the rack 14 in the displacement direction.

In one exemplary arrangement, the first end portion 44 and the second end portion 48 each have a constant circular cross section with the same diameter.

In principle, however, each of the end portions 44, 48 can have any desired cross section.

In order to guide the rack 14 in the motor vehicle, the steering system comprises a rack guide 52 having a first bearing bushing 54 and a second bearing bushing 55, which each support the rack 14 on the periphery.

The first bearing bushing 54 is arranged in the first end portion 44 and the second bearing bushing 55 is arranged in the second end portion 48. The contact region 34 is thus arranged between the toothing 30 and the drive shaft 28 in the direction of the longitudinal axis L between the two bearing bushings 54, 55, and in one particular arrangement, in the middle.

In FIGS. 1 and 2, the steering system 10 is in a neutral position, i.e. in a position in which the wheels of the motor vehicle are oriented in the primary direction of movement of the motor vehicle, usually straight ahead.

In this neutral position, the drive shaft 28 is arranged centrally with respect to the rack 14 and the toothing 30 in the direction of the longitudinal axis L, so that the rack 14 can be adjusted equally in both directions when steering, i.e. to the left and to the right.

The location or relative position of the rack 14 with respect to the drive shaft 28 can be determined, for example, by an angle sensor or a rotary encoder which is connected to the control unit 20 so as to transmit signals.

In the exemplary arrangement shown, the steering system 10 also has a wireless torque sensor 56, which is connected to the control unit 20 so as to transmit signals and is set up to determine a torque transmitted by the drive shaft 28 or acting in the drive shaft 28.

Using the sensor data, the control unit 20 controls the electric drive 16 in order to adjust or translate steering movements of the steering wheel 12 into a corresponding relative position of the rack 14.

Of course, in addition or as an alternative to steering movements of the steering wheel 12, other control signals can be taken into account by the control unit, in particular control signals that support a driver, for example when keeping in lane, or directly predetermine a trajectory, for example in an autonomous driving or parking mode.

With reference to FIG. 4, a steering system 10 is now described according to a further exemplary arrangement. The same reference signs are used for the components which are known from the above arrangement and reference is made to the preceding explanations in this respect.

In contrast to the arrangement shown in FIGS. 1 and 2, the steering system 10 shown in FIG. 4 comprises a worm gear 22 having a second worm shaft 58, which is provided in addition to the first worm shaft 26 and which engages with the worm wheel 24.

The first electric motor 18 is connected via the first worm shaft 26 and the second electric motor 19 via the second worm shaft 58 to the worm wheel 24 and thus to the drive shaft 28 so as to transmit torque.

The two worm shafts 26, 58 are arranged such that the worm wheel 24 is arranged between the two worm shafts 26, 58 and the axes of rotation E, F of the worm shafts 26, 58 extend parallel to one another.

In all exemplary arrangements shown, a steering system 10 is provided in this way, by which the relative position of the rack 14 can be set particularly reliably and precisely and the motor vehicle can thus be precisely steered.

The worm gear 22 ensures a particularly resilient, effective and low-noise transmission of the forces from the electric drive 16 to the drive shaft 28.

Furthermore, the rack 14 and the rack guide 52 are designed in such a way that the rack 14 is particularly resistant to deflecting.

The disclosure is not limited to the disclosed arrangements. In particular, individual features of one exemplary arrangement can be combined as desired with features of other arrangements, in particular independently of the other features of the corresponding arrangements.

1. A steering system for a motor vehicle, which is designed as a steer-by-wire steering system, wherein the steering system comprises a rack, an electric drive for longitudinal displacement of the rack, a worm gear and a drive shaft which is in toothed engagement with the rack, wherein the electric drive is connected to the drive shaft by the worm gear so as to transmit torque.

2. The steering system according to claim 1, wherein the worm gear has a worm wheel and a worm shaft which engages with the worm wheel, the worm wheel being connected to the drive shaft so as to transmit torque and the worm shaft being connected to the electric drive so as to transmit torque.

3. The steering system according to claim 2, wherein the electric drive comprises a first electric motor and a second electric motor.

4. The steering system according to claim 3, wherein the first electric motor and the second electric motor are connected to the worm wheel by the worm shaft so as to transmit torque.

5. The steering system according to claim 3, wherein the worm gear has a second worm shaft which engages with the worm wheel, the first worm shaft being connected to the first electric motor so as to transmit torque and the second worm shaft being connected to the second electric motor so as to transmit torque.

6. The steering system according to claim 5, wherein the first worm shaft and the second worm shaft are arranged on mutually opposite radial sides of the worm wheel.

7. The steering system according to claim 1, wherein the steering system has two bearing bushings which are spaced apart from one another in the longitudinal direction of the rack, the bearing bushing together forming a rack guide, the drive shaft being arranged in a longitudinal direction of the rack between the two bearing bushings.

8. The steering system according to claim 1, wherein the drive shaft is arranged, in in a neutral position of the steering system, centrally with respect to the rack in the longitudinal direction of the rack.

9. The steering system according to claim 1, wherein the steering system has a pressure piece which is arranged in the region of the drive shaft and which supports the rack.

10. The steering system according to wherein the steering system has wireless torque sensor which is provided for determining the torque of the drive shaft.

11. The steering system according to claim 1, wherein the rack has a toothing, the drive shaft being in toothed engagement with the rack via the toothing, the rack having a constant cross section in each case from a first end to the toothing and from the toothing to a second end opposite the first end.

12. The steering system of claim 6, wherein the axis of rotation of the first worm shaft extends parallel to the axis of rotation of the second worm shaft.

13. The steering system of claim 5, wherein the steering system has two bearing bushings which are spaced apart from one another in the longitudinal direction of the rack, the bearing bushing together forming a rack guide, the drive shaft being arranged in a longitudinal direction of the rack between the two bearing bushings.

14. The steering system of claim 9, wherein the pressure piece is made of a plastics material.

15. The steering system of claim 9, wherein the steering system further includes a spring element that acts upon the pressure piece with a spring force in a direction of the rack.

16. The steering system of claim 9, wherein the pressure piece includes a contact surface that is constructed with a geometry that is complementary to a geometry of the rack.

17. The steering system of claim 1, wherein an axis of rotation of the drive shaft is inclined by an angle of less than 9dwith respect to a longitudinal axis of the rack.

18. The steering system of claim 11, wherein the toothing is provided only in a toothed portion such that the toothing does not extend in a direction of a longitudinal axis over the entire length of the rack.

19. The steering system of claim 18, wherein the length of the tooth portion corresponds to a maximum translational movement range of the rack in a displacement direction.

20. The steering system of claim 1, wherein a first end portion of the rack and a second end portion of the rack each have a constant circular cross section with the same diameter.
